(19) United States
(12) Patent Application Publication
(10) Pub. No.: US 2025/0347297 A1
(43) Pub. Date: Nov. 13, 2025

(54) FEEDBACK CONTROLLED GAS LIFT CONVEYANCE OF SLURRY

(71) Applicant: NEXOM INC., Winnipeg (CA)

(72) Inventor: Cornelius Joseph Strain, Winnipeg (CA)

(21) Appl. No.: 19/184,755

(22) Filed: Apr. 21, 2025

Related U.S. Application Data
(60) Provisional application No. 63/644,007, filed on May 8, 2024.

(51) Int. Cl. F04F 1/14; B01D 24/16; B01D 24/40; B01D 24/42; B01D 24/48; G01L 19/12; G08B 21/18

(52) U.S. Cl. CPC F04F 1/14; B01D 24/16; B01D 24/40; B01D 24/425; B01D 24/4876; G01L 19/12; G08B 21/182; B01D 2101/04; B01D 2201/54

(57) ABSTRACT

A gas lift conveyance device moves a slurry through an upwardly extending lifting section of a conduit in communication from a source location at a first pressure to a discharge location at a lesser second pressure. A gas injector of the device injects gas into the conduit through a variable position valve that is controlled by a controller that uses a representative value measured by a sensor as input to a closed loop control algorithm of the controller. The representative value may be a pressure or flow rate that is representative of the gas delivery rate. The device provides: (i) automated control over the delivery rate of slurries; (ii) real time values of air rate, valve position, and pressure; (iii) a reduction of energy input due to optimal use of air; and (iv) a reduction in air pumps stalling or plugging failures.

This application claims the benefit under 35 U.S.C. 119(e) of U.S. provisional application Ser. No. 63/644,007, filed May 8, 2024.

### FIELD OF THE INVENTION

The present invention relates to a gas lift conveyance device for lifting a slurry within a conduit using a gas injected into the conduit, and more particularly the present invention relates to a gas lift conveyance device in which gas injection is controlled based upon feedback from a sensed value.

### BACKGROUND

Airlift pumps are used in the transfer of liquids and slurries, especially when dealing with highly abrasive materials that cannot pass through a mechanical pump or transfer device. These pumps can use Rudimentary concepts of airlift pumps in use for decades can be summarized as a) transport pipe or hoses delivering from a lower to a higher elevation (or the corollary of higher pressure to lower pressure) with b) air injection located such that air will rise by gravity to the discharge end, delivering the transport media as it discharges. Air control into the tube injector is typically accomplished with basic mechanical equipment such as pressure regulators, needle valves, and site gauges.

Use of airlift pumps can find additional subcategories of use where transfer of slurries is relevant for varying operational aspects of filtration technologies, such as granular media filters, membrane filters and other related technologies. Examples of airlift pumps for conveying granular filtration media are described in U.S. Pat. Nos. 8,047,808; 8,771,521; 8,696,896; and 8,658,031.

### SUMMARY OF THE INVENTION

According to one aspect of the invention there is provided a gas lift conveyance device for moving a slurry through an upwardly extending lifting section of a conduit in communication from a source location at a first pressure to a discharge location at a second pressure which is less than the first pressure, the device comprising:
a gas injector arranged to inject a gas into the lifting section of the conduit such that the gas lifts the slurry along the lifting section of the conduit towards the discharge location;
a variable position valve arranged for connection between the gas injector and a gas source of gas under pressure, the variable position valve being operable to controllably vary a gas delivery rate of the gas under pressure from the gas source to the gas injector;
a sensor operative to measure a representative value in which the representative value is representative of the gas delivery rate; and
a controller arranged to control the variable position valve to controllably vary the gas delivery rate at least in part based on said representative value.

Preferably, the controller is arranged to maintain closed loop control of the variable position valve based on the representative value measured by the sensor, for example using a proportional-integral-derivative control algorithm having a target value to maintain said closed loop control of the variable position valve based on the representative value measured by the sensor as input for comparison to the target value.

The invention provides an airlift controller and air distribution system to reduce energy consumption and optimize the performance of airlift pumps. The rate of transfer for slurries has been found to correlate to the air input and the delivery backpressure, which can be described as friction or headloss in units of pressure. Closed loop control of the airflow will give control of the slurry pumping rate. Slurry delivery rate tolerances can vary by application (type of slurry) and the size of the airlift pump (tube diameter from 0.5″ to 12″ typical).

This invention aims at simplifying and automating the airlift pump control. More particularly the present invention provides: (i) automated control over the delivery rate of slurries, (ii) real time values of air rate, valve position, and pressure for controller closed loop functions and process alarms, (iii) a reduction of energy input because energy input is directly related to air input and these parameters can be used in closed loop logic control to allow optimal use of air input, and (iv) a reduction in the failures of air pumps in the form of stalling or plugging due to loss of air or lack of sufficient air delivery.

The sensor may be (i) a flow sensor arranged to measure a flow rate of the gas delivered to the gas injector, (ii) a pressure sensor arranged to measure a pressure of the gas delivered to the gas injector, and/or (iii) a pressure sensor arranged to measure a pressure within the lifting section of the conduit.

The controller may communicate with the variable position valve intermittently and/or with the sensor intermittently.

Preferably the sensor is arranged to communicate the representative value as digital information to the controller.

When the controller is operable in response to user input received from the user, the device may further comprise a user interface operable on a user computer device located remotely from the controller in which the user interface is arranged to receive said user input from the user and communicate the user input to the controller over a communications network. The user interface may be operable on a mobile computer device and is arranged to communicate the user input to the controller over a wireless communications network.

The device may further include a pressure monitor arranged to measure a pressure of the gas prior to injection into the conduit, in which the controller is arranged to generate an alarm notification if the measured pressure is outside of a threshold range of pressures.

The device may further include a pressure monitor arranged to measure a pressure in the conduit in which the controller is arranged to generate an alarm notification if the measured pressure is outside of a threshold range of pressures.

The slurry may comprise a liquid containing granular filtration media therein. More particularly, the device may be used with a filtration apparatus having a filtration chamber containing the granular filtration media therein for filtering a liquid mixture passing through the filtration chamber, in which the source location of the conduit is within the filtration chamber such that the slurry conveyed by the conduit includes a portion of the liquid mixture and a portion of the granular filtration media within the filtration chamber.

The device may further comprise (i) a first gas line in communication between the gas source and the gas injector in which the variable position valve is mounted in series with the first gas line such that the gas delivery rate through the first gas line is controlled by the variable position valve, and (ii) a second gas line in communication between the gas source and the gas injector independently of the variable position valve in which the second gas line includes a control valve mounted in series with the second gas line. In this instance, the second gas line and the control valve are preferably operable to deliver gas through the second gas line at a higher gas delivery rate than the first gas line.

The device may further include a gas conditioner in communication between the gas source and the variable position valve so as to be arranged to filter and dry the gas delivered to the variable position valve.

The gas may comprise air, or alternatively consist of nitrogen.

The device may further include a plurality of gas injectors arranged to be operatively connected to respective conduits in which each gas injector has (i) a respective variable position valve for controlling the gas delivery rate through the respective conduit and (ii) a respective sensor for measuring a representative value that is representative of the gas delivery rate through the respective conduit. In this instance, the controller is preferably arranged to control each variable position valve to controllably vary the gas delivery rate through the respective conduit at least in part based on the representative value measured by the respective sensor.

### BRIEF DESCRIPTION OF THE DRAWINGS

Some embodiments of the invention will now be described in conjunction with the accompanying drawings in which:

FIG. 1 is a schematic representation of the gas lift conveyance device according to one exemplary embodiment of the present invention;

FIG. 2 is a schematic representation of the closed loop control of the gas injection of the gas lift conveyance device;

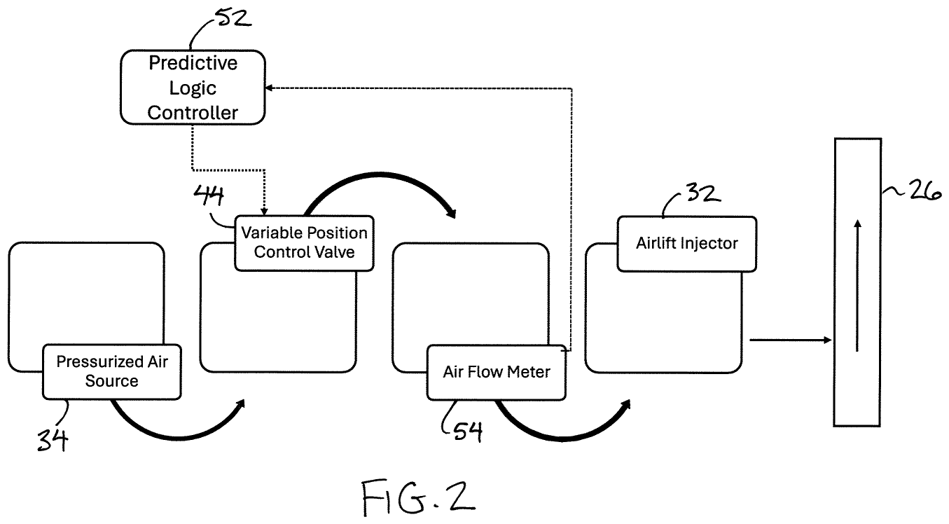

FIGS. 3A, 3B and 3C are schematic representations of various conduits having respective lifting sections into which the gas is injected for lifting the slurry therein; and

FIG. 4 is a schematic representation of the piping for a second embodiment of the gas lift conveyance device in which a common controller provides control for a plurality of gas injection associated with different lifting conduits.

In the drawings like characters of reference indicate corresponding parts in the different figures.

### DETAILED DESCRIPTION

Referring to the accompanying figures there is illustrated a gas lift conveyance device generally indicated by reference numeral 10. The device 10 uses gas injected into a slurry for lifting the slurry from a source location to a discharge location. The gas lift conveyance device 10 uses a programmable logic controller or programmable relay that (i) receives inputs related to gas delivery flow or rate and (ii) provides closed loop control of the air delivery in order to maintain a slurry delivery rate within given tolerances. The controller output would be a valve position to tighten or relax valve constriction and deliver a target gas rate. The feedback signal for the controller would be a measured value representative of the gas delivery rate. The accuracy of control and the correlation of air rate to slurry pumping rates for various media requires feedback on backpressure (friction losses), which can be measured directly or calculated by the controller based on the air rate and the valve position.

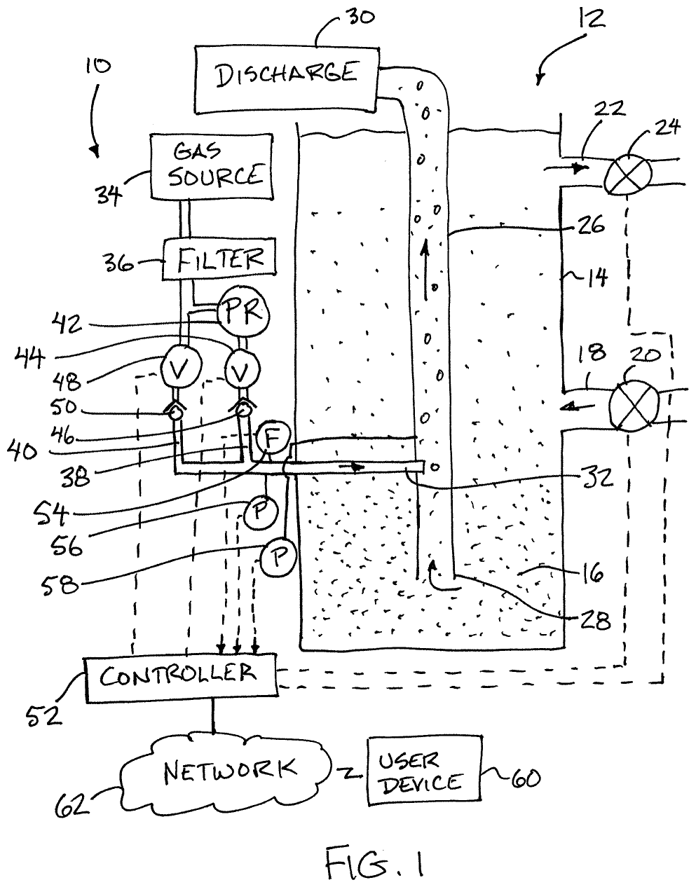

In one exemplary embodiment, the gas lift conveyance device 10 is used within a filtration apparatus 12 as shown in FIG. 1. The filtration apparatus 12 generally includes a filtration chamber 14 filled with a granular filtration media 16 such as sand. A liquid inlet 18 is in communication with the filtration chamber to receive an influent of a liquid with suspended solids therein to be filtered as it passes upwardly through the sand in the filtration chamber. The liquid inlet 18 communicates with the filtration chamber at a location spaced upwardly from the bottom of the chamber which is typically nearer to the bottom than the top end. An inlet valve 20 connected in series with the liquid inlet 18 controls the flow of liquid to be filtered into the chamber. A liquid outlet 22 is in communication with the filtration chamber at a location spaced above the liquid inlet 18 for receiving liquid effluent exiting the filtration chamber after the liquid has passed through the filtration media 16. An outlet valve 24 is provided in connection with the liquid outlet 22 to regulate the effluent flow.

The conveyance device 10 in the illustrated example comprises a conduit 26 in the form of a rigid pipe extending upwardly from an open bottom end 28 in open communication with the filtration chamber 14 at a location spaced below the liquid inlet 18 to define a source location to a top end connected to a discharge 30 defining a discharge location of the conveyance device. In the illustrated embodiment, the conduit is vertical between the source location and the discharge location such that the entirety of the conduit defines a lifting section through which the injected gas lifts the slurry.

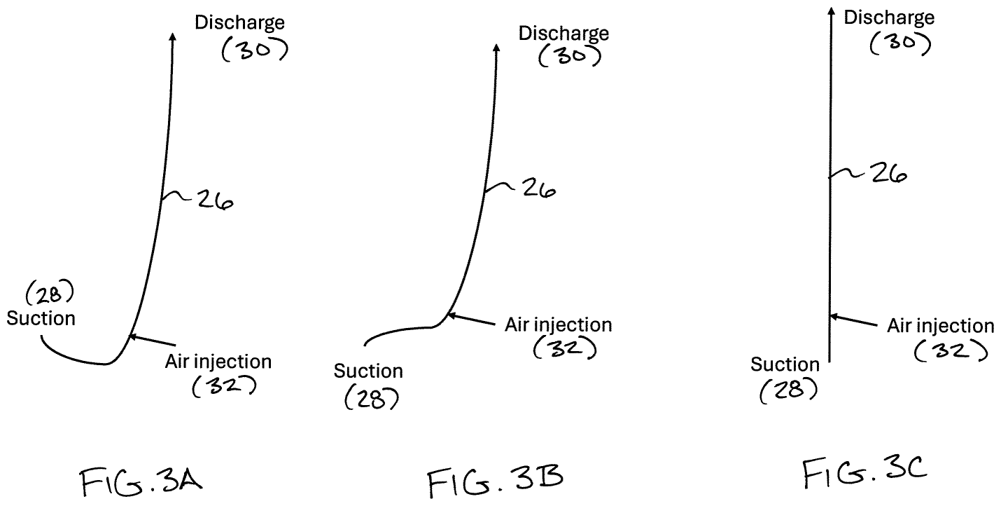

In further embodiments as shown in FIGS. 3A, 3B, and 3C, the conduit 26 may take various forms of flexible or rigid pipes in various configurations which may include a horizontal inlet section or varying upwardly sloping sections; however, in each instance the conduit includes a lifting section that extends continuously upward from the location of gas injection to the discharge location such that the injected gas is permitted to continuously rise towards the discharge location while conveying the slurry together with the rising gas.

The upward movement of gas and slurry within the lifting section of the conduit causes a negative pressure at the inlet of the conduit 26 which draws some of the liquid within the filtration chamber into the conduit together with some of the filtration media at the bottom of the filtration chamber. The mixture of liquid and suspended granular filtration particles are conveyed upwardly to the discharge location where the filtration media may be discarded to waste or washed for reuse by reintroducing cleaned sand into the top of the filtration chamber.

The device 10 further includes a gas injector 32 in the form of one or more nozzles in communication with the interior of the conduit 26 at a location spaced slightly above the bottom of the conduit so that injected gas flows only upwardly into the conduit 26 to drive upward flow in the conduit.

The gas is injected from a gas source 34 which is a source of pressurized or compressed gas from a pump or compressor, or a pressurized storage tank. The gas may be air or may consist only of nitrogen. In each instance, the gas from the gas source is first passed through a filter 36 and or conditioner which filters and dries the gas prior to delivering the gas to downstream components.

The dried and filtered gas is then communicated through a tee into a first gas line 38 and a second gas line 40 in parallel with one another.

The first gas line 38 passes through a pressure regulator 42 which regulates the pressure to a reduced pressure value, for example 40 psig. The reduced pressure gas is then directed to a variable position valve 44 which can be adjusted to provide variable control to the gas delivery rate therethrough to the gas injector 32. More particularly, the variable position valve 44 provides an adjustable restriction that can be set at any one of numerous positions between a fully open position and a fully closed position to change the size of the orifice through which gas is delivered which in turn varies the gas delivery rate. The gas flow is then directed through a check valve 46 that allows flow in only one direction towards the gas injector 32 for delivering the gas from the gas source 34 to the gas injector 32 at a controlled flow rate.

The second gas line 40 is directed through a control valve 48 at a full unregulated pressure greater than the first gas line, for example in the range of 80 to 100 psig. The control valve 48 is typically only operated between a fully open position to deliver a burst of high-pressure gas to the gas injector when desired and a fully closed position when the gas flow is desired to be delivered at a controlled rate determined by the variable position valve 44 in the first gas line. The second gas line also includes a check valve 50 operable to only allow flow in one direction towards the gas injector 32. The first gas line 38 and the second gas line 40 are reconnected with one another downstream of the check valves 46 and 50 before reaching the gas injector.

A controller 52 is provided such as a programmable logic controller comprising a computer having a memory with program instructions stored thereon and a processor arranged to execute the program instructions to perform the various functions of the controller described herein. The controller 52 communicates with the variable position valve 44 to control the position of the valve between the open and closed positions thereof by communicating digital control signals from the controller to the valve. The control signals may be communicated intermittently at prescribed intervals to minimize wear on the variable position valve 44 while still regularly adjusting the variable position valve to achieve a desired flow rate.

The controller 52 may also be in communication with the control valve 48 of the second gas line 40 to control when a high-pressure burst of gas is delivered.

The controller may also be in communication with the inlet valve 20 and the outlet valve 24 of the filtration apparatus 12 to control the flow of liquid being filtered through the filtration chamber of the apparatus.

The controller 52 also communicates with a plurality of sensors providing feedback to the controller so that the controller can provide closed-loop control of the variable position valve 44. The sensors are preferably arranged to communicate measured values as digital information reported to the controller.

In a preferred arrangement the sensors include a flow rate sensor 54 in communication with the first gas line 38 between the variable position valve 44 and the gas injector for measuring the gas delivery rate as a volumetric or mass flow rate of gas through the first gas line. The controller may communicate intermittently with the flow rate sensor 54 to measure the flow rate intermittently at prescribed intervals corresponding to the response intervals of the variable position valve control.

In further embodiments, the controller 52 may communicate with a first pressure sensor 56 in communication with the first gas line 38 between the variable position valve 44 and the gas injector to measure the pressure of the delivered gas. The measured gas pressure can be used as an additional input to the controller or in place of the flow rate sensor.

In yet further embodiments, the controller 52 may communicate with a second pressure sensor 58 which measures the pressure within the conduit 26 downstream from the gas injection. The measured pressure in the conduit can be used as an additional input to the controller or in place of the flow rate sensor.

As described herein, the controller communicates with all of the sensors to receive measured values at periodic reporting intervals. Based on the inputs and preferably in a closed loop control based on the flow rate measured by the flow rate sensor 54, the controller follows a suitable control algorithm to control the position of the valve 44. Preferably the controller uses a proportional-integral-derivative control algorithm to generate response signals for the variable position valve 44 to reposition the valve to achieve a targeted delivery rate of the gas through the injector 32.

The controller can also use the sensors to monitor if various measured values fall outside of respective threshold ranges by either being above an upper threshold or below a lower threshold. In particular, the controller may generate an alarm notification after comparing the measured pressure from the first pressure sensor 56 to a threshold range and determining that the measured pressure is outside of the range. Similarly, the controller may generate an alarm notification after comparing the measured pressure from the second pressure sensor 58 and determining that the measured pressure is outside of the threshold range. The controller can also generate alarm notifications in response to any of the valves not responding in the expected manner to response signals so as to be indicative of a valve failure.

The controller may vary the operating parameters such as the target gas rate to be achieved or the type of control algorithm and the corresponding constants being applied to the algorithms in response to user input received through a user interface operating on a user computer 60. The user computer typically comprises a personal computer device such as a laptop computer, tablet or smart phone comprising a memory storing a user interface as program instructions thereon and a processor for executing the program instructions. The controller and the computer device 60 are arranged to communicate with one another over a suitable communications network 62 such as a local wired network, the Internet, or a wireless communications network such as a cellular network when the user computer device is a mobile device for example. In each instance the user interface on the user computer 60 can be located remotely from the controller, the sensors, and the valves controlled by the controller.

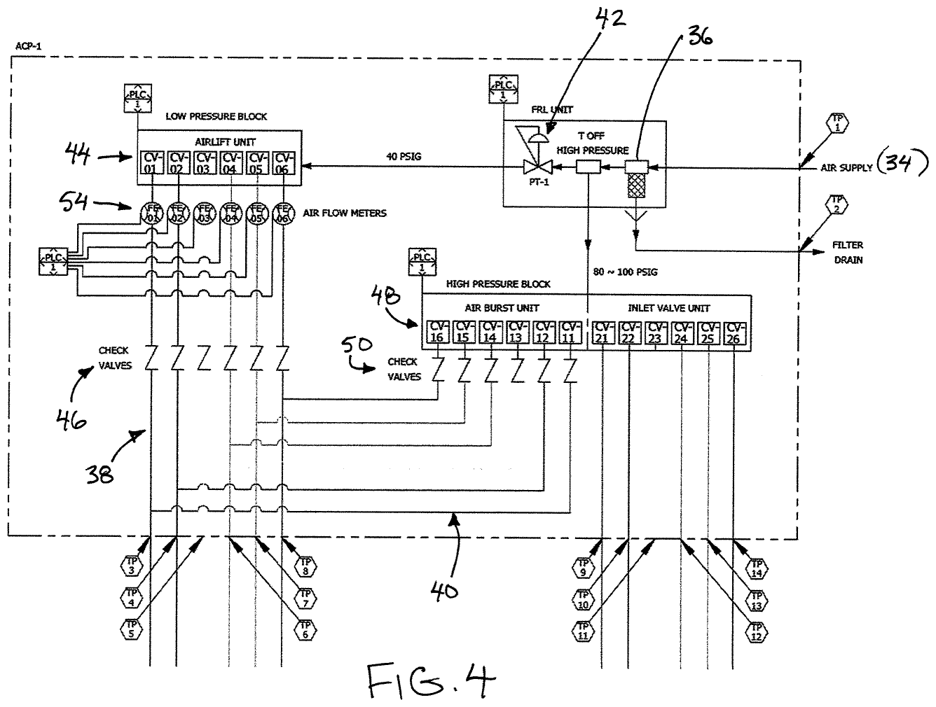

In yet further embodiments, as represented schematically in FIG. 4, a single controller 52 may be operatively associated with a plurality of filtration apparatuses 12. In this instance each filtration apparatus 12 includes a respective conduit 26 having an associated gas injector 32 for injecting gas into the conduit, a variable position valve 44 for controlling the delivery rate of gas through the injector 32, and a flow rate sensor 54 for measuring a value representative of the gas delivery rate through the injector, however, the common controller 52 receives inputs from all of the sensors and generates response signals for all of the variable position valves 44 using similar algorithms to generate the response signals to provide closed-loop control of the gas delivery within each of the filtration apparatuses independently of one another.

Aspects that can be varied without changing the object of the invention include: (i) Size dimensions and geometry of the airlift pump tube so long as it delivers from a suction of higher pressure to a discharge of lower pressure, (ii) Size dimensions of the airlines and air control valves, (iii) The type and size of air control valves so long as they can be variably positioned (not simply open-close), (iv) The number of airlift pumps controlled by a single controller, and (v) Proximity of the controller or relay, control valves and airlift pump with respect to each other.

Since various modifications can be made in the invention as herein above described, and many apparently widely different embodiments of same made, it is intended that all matter contained in the accompanying specification shall be interpreted as illustrative only and not in a limiting sense.

Claims:

1. A gas lift conveyance device for moving a slurry through an upwardly extending lifting section of a conduit in communication from a source location at a first pressure to a discharge location at a second pressure which is less than the first pressure, the device comprising:
a gas injector arranged to inject a gas into the lifting section of the conduit such that the gas lifts the slurry along the lifting section of the conduit towards the discharge location;
a variable position valve arranged for connection between the gas injector and a gas source of gas under pressure, the variable position valve being operable to controllably vary a gas delivery rate of the gas under pressure from the gas source to the gas injector;
a sensor operative to measure a representative value in which the representative value is representative of the gas delivery rate; and
a controller arranged to control the variable position valve to controllably vary the gas delivery rate at least in part based on said representative value.

2. The device according to claim 1 wherein the controller is arranged to maintain closed loop control of the variable position valve based on the representative value measured by the sensor.

3. The device according to claim 2 wherein the controller is arranged to use a proportional-integral-derivative algorithm having a target value to maintain said closed loop control of the variable position valve based on the representative value measured by the sensor as input for comparison to the target value of the proportional-integral-derivative algorithm.

4. The device according to claim 1 wherein the sensor is a flow sensor arranged to measure a flow rate of the gas delivered to the gas injector.

5. The device according to claim 1 the sensor is a pressure sensor arranged to measure a pressure of the gas delivered to the gas injector.

6. The device according to claim 1 the sensor is a pressure sensor arranged to measure a pressure within the lifting section of the conduit.

7. The device according to claim 1 wherein the controller communicates with the variable position valve intermittently.

8. The device according to claim 1 wherein the controller communicates with the sensor intermittently.

9. The device according to claim 1 wherein the sensor is arranged to communicate the representative value as digital information to the controller.

10. The device according to claim 1 wherein the controller is operable in response to user input received from the user, the device further comprising a user interface operable on a user computer device located remotely from the controller, the user interface being arranged to receive said user input from the user and communicate the user input to the controller over a communications network.

11. The device according to claim 10 wherein the user interface is operable on a mobile computer device and is arranged to communicate the user input to the controller over a wireless communications network.

12. The device according to claim 1 further comprising a pressure monitor arranged to measure a pressure of the gas prior to injection into the conduit and wherein the controller is arranged to generate an alarm notification if the measured pressure is outside of a threshold range of pressures.

13. The device according to claim 1 further comprising a pressure monitor arranged to measure a pressure in the conduit and wherein the controller is arranged to generate an alarm notification if the measured pressure is outside of a threshold range of pressures.

14. The device according to claim 1 wherein the slurry comprises a liquid containing granular filtration media therein.

15. The device according to claim 14 in combination with a filtration apparatus having a filtration chamber containing the granular filtration media therein for filtering a liquid mixture passing through the filtration chamber, wherein the source location of the conduit is within the filtration chamber such that the slurry conveyed by the conduit includes a portion of the liquid mixture and a portion of the granular filtration media within the filtration chamber.

16. The device according to claim 1 further comprising a first gas line in communication between the gas source and the gas injector in which the variable position valve is mounted in series with the first gas line such that the gas delivery rate through the first gas line is controlled by the variable position valve, and a second gas line in communication between the gas source and the gas injector independently of the variable position valve in which the second gas line includes a control valve mounted in series with the second gas line, the second gas line and the control valve being operable to deliver gas through the second gas line at a higher gas delivery rate than the first gas line.

17. The device according to claim 1 further comprising a gas conditioner in communication between the gas source and the variable position valve so as to be arranged to filter and dry the gas delivered to the variable position valve.

18. The device according to claim 1 wherein the gas comprises air.

19. The device according to claim 1 wherein the gas consists of nitrogen.

20. The device according to claim 1 further comprising:
a plurality of gas injectors arranged to be operatively connected to respective conduits;
each gas injector having (i) a respective variable position valve for controlling the gas delivery rate through the respective conduit and (ii) a respective sensor for measuring a representative value that is representative of the gas delivery rate through the respective conduit;
wherein the controller is arranged to control each variable position valve to controllably vary the gas delivery rate through the respective conduit at least in part based on the representative value measured by the respective sensor.
